(19) United States
(12) Patent Application Publication
(10) Pub. No.: US 2023/0307930 A1
(43) Pub. Date: Sep. 28, 2023

(54) SPEAKER SYSTEM

(71) Applicant: YAMAHA CORPORATION, Hamamatsu-shi (JP)

(72) Inventors: Yuumi KUROSAKA, Hamamatsu-shi (JP); Katsumasa KOSUGE, Hamamatsu-shi (JP); Kazuya WASHIO, Arcadia, CA (US)

(21) Appl. No.: 18/183,461

(22) Filed: Mar. 14, 2023

(30) Foreign Application Priority Data
Mar. 23, 2022 (JP) 2022-046270

(51) Int. Cl. H02J 7/00; H04R 1/02

(52) U.S. Cl. CPC H02J 7/0044; H04R 1/026

(57) ABSTRACT

A speaker system includes: a portable speaker including a first locking member; and a charging base including a second locking member. The first locking member is configured to slide in: a first direction relative to the second locking member to lock the first and second locking members together; and a second direction, which is opposite to the first direction, relative to the second locking member to release the first locking member from the second locking member.

### CROSS-REFERENCE TO RELATED APPLICATIONS

This application is based on and claims priority under 35 USC 119 from Japanese Patent Application No. 2022-046270 filed on Mar. 23, 2022, the contents of which are incorporated herein by reference.

### TECHNICAL FIELD

The present disclosure relates to a speaker system.

10

### BACKGROUND ART

A speaker system is disclosed in “Sonos Roam & amp; Wireless Charger Set Sonos Official Online Store”, online, Sonos Inc., Searched on Feb. 15, 2022, (URL: www.sonos.com/ja-jp/shop/roam-and-wireless-charger-set.html). The speaker system includes a portable speaker capable of being carried and a charging base on which the portable speaker can be attached for charging.

### SUMMARY OF INVENTION

In the above mentioned speaker system, in a case of attaching the portable speaker on the charging base, the portable speaker is merely placed on the charging base. Therefore, although the portable speaker can be easily attached to and detached from the charging base, the portable speaker may accidentally be detached from the charging base without intention.

The present disclosure has been made in view of the circumstances described above, and an object thereof is to provide a speaker system capable of easily attaching and detaching a portable speaker to and from a charging base and preventing the portable speaker from being accidentally detached from a charging base in a state where the speaker is attached on the charging base.

The present provides a speaker system including: a portable speaker including a first locking member; and a charging base including a second locking member, wherein the first locking member is configured to slide in: a first direction relative to the second locking member to lock the first and second locking members together; and a second direction, which is opposite to the first direction, relative to the second locking member to release the first locking member from the second locking member.

According to the present disclosure, the portable speaker can be easily attached to and detached from the charging base, and it is possible to prevent the portable speaker from being accidentally detached from the charging base in a state where the speaker is attached on the charging base.

### BRIEF DESCRIPTION OF DRAWINGS

The present disclosure will be described in detail based on the following figures, wherein:

FIG. 1 is a perspective view illustrating a speaker system according to a first embodiment of the present disclosure, in which a portable speaker is attached on a charging base;

FIG. 2 is an enlarged perspective view illustrating a principal portion of the speaker system illustrated in FIG. 1, in which the portable speaker is detached from the charging base;

FIG. 3 is an enlarged perspective view of a state illustrated in FIG. 2 when viewed from another angle;

FIG. 4 is an enlarged perspective view illustrating a principal portion of the speaker system illustrated in FIG. 1, in which a locking protrusion is detached from a recess portion of the portable speaker;

FIG. 5 is a plan view of a principal portion of the charging base in FIGS. 1 to 4 when viewed from a contact surface side;

FIG. 6 is an enlarged sectional view illustrating a principal portion of the speaker system illustrated in FIG. 1;

FIG. 7 is a sectional view taken along line VII-VII in FIG. 6;

FIG. 8 is an enlarged sectional view illustrating a state where the portable speaker is detached from the charging base from the state illustrated in FIG. 7;

FIG. 9 is an enlarged sectional view illustrating a modification example of a holding mechanism illustrated in FIGS. 7 and 8;

FIG. 10 is a schematic view illustrating a speaker system according to a second embodiment of the present disclosure, in which a portable speaker is detached from a charging base; and

FIG. 11 is an enlarged sectional view illustrating a principal portion of the speaker system illustrated in FIG. 10, in which the portable speaker is attached on the charging base.

### DESCRIPTION OF EMBODIMENTS

### First Embodiment

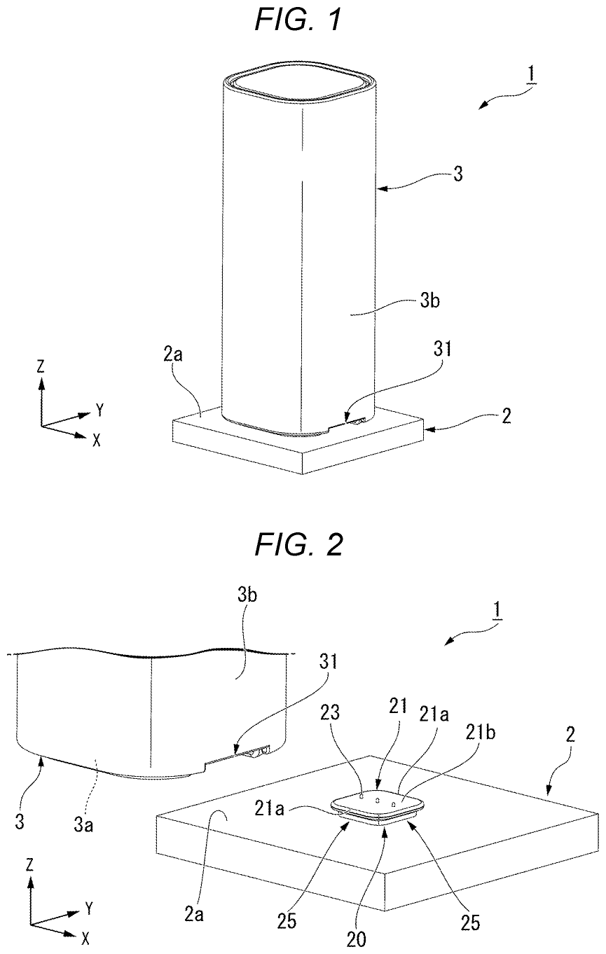

A first embodiment of the present disclosure will be described below with reference to FIGS. 1 to 8.

As illustrated in FIGS. 1 to 3, a speaker system 1 of the present embodiment includes a charging base 2 and a portable speaker 3 detachably attached on the charging base 2.

The charging base 2 charges the portable speaker 3 in a state where the portable speaker 3 is attached on the charging base 2. The charging base 2 has a contact surface 2a with which the portable speaker 3 comes into surface contact. The charging base 2 of the present embodiment is disposed such that the contact surface 2a of the charging base 2 is oriented toward the upper side (upward) of the vertical direction, and such that the contact surface 2a of the charging base 2 is oriented substantially along the horizontal direction. That is, the contact surface 2a of the charging base 2 functions as a placing surface on which the portable speaker 3 is placed.

The charging base 2 may be fixed to, for example, a wall surface extending in the vertical direction or may be disposed on a table, for example, in a state where the contact surface 2a of the charging base 2 is oriented upward.

In the present embodiment, the positional relationship in each configuration will be described by setting an XYZ orthogonal coordinate system. The X-axis direction represents one direction along the contact surface 2a of the charging base 2. The Y-axis direction represents another direction along the contact surface 2a of the charging base 2. The Z-axis direction represents the vertical direction. In addition, the Z-axis positive direction represents an upper side (upward) in the vertical direction, and the Z-axis negative direction represents a lower side (downward) in the vertical direction.

The portable speaker 3 is connected to a device (not illustrated) in a wired or wireless manner to generate sound based on data transmitted from the device. The portable speaker 3 includes a rechargeable battery (not illustrated) and can operate without supplying electric power from the outside.

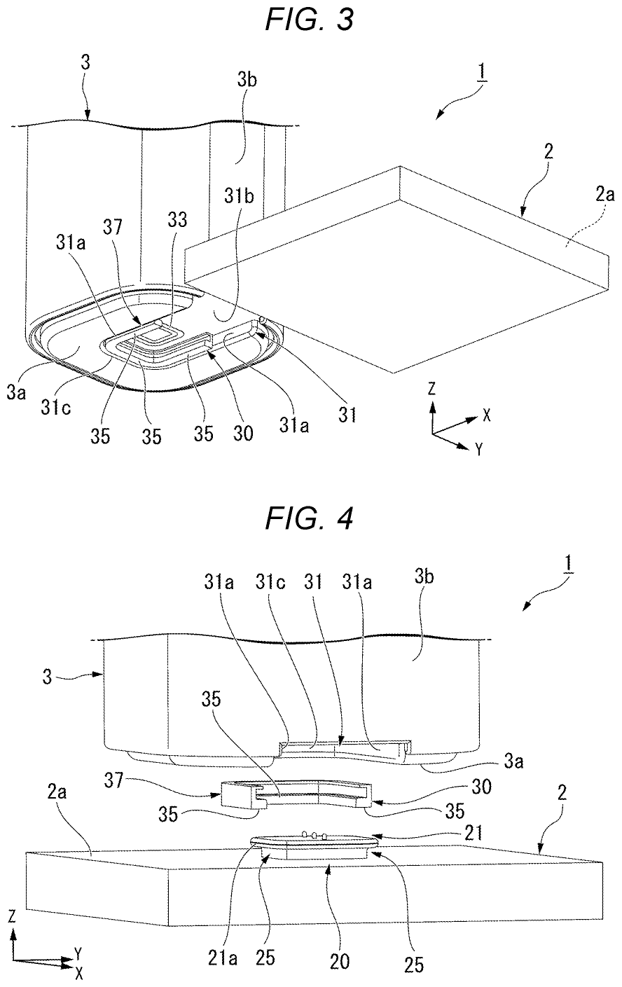

As illustrated in FIG. 1, in a state where the portable speaker 3 is attached on the charging base 2, electric power is supplied from the charging base 2 to the rechargeable battery of the portable speaker 3, and thus the rechargeable battery is charged. Charging of the portable speaker 3 in the present embodiment is performed by wired charging. Specifically, as illustrated in FIGS. 2 and 3, the charging base 2 and the portable speaker 3 are provided with connection terminals 23 and 33 for charging, respectively. When the connection terminals 23 and 33 come into contact with each other in a state where the portable speaker 3 is attached on the charging base 2, the portable speaker 3 and the charging base 2 are electrically connected to each other, and thus the portable speaker 3 can be charged by wired charging. In the present embodiment, the connection terminal 23 of the charging base 2 is provided on a distal end surface 21b of a protrusion portion 21 described later. The connection terminal 33 of the portable speaker 3 is provided on a bottom surface 31b of a recess portion 31 described later.

As illustrated in FIG. 6, in a state where the portable speaker 3 is attached on the charging base 2, the first locking member 30 of the portable speaker 3 is locked to a second locking member 20 of the charging base 2 in the direction perpendicular to the contact surface 2a (Z-axis direction). The first locking member 30 and the second locking member 20 are locked by slidably moving the portable speaker 3 in the first direction along the contact surface 2a of the charging base 2 with respect to the charging base 2. In addition, the locked state between the first locking member 30 and the second locking member 20 is released by slidably moving the portable speaker 3 in the second direction opposite to the first direction with respect to the charging base 2. Hereinafter, the configuration of the speaker system 1 of the present embodiment including the first locking member 30 and the second locking member 20 will be specifically described.

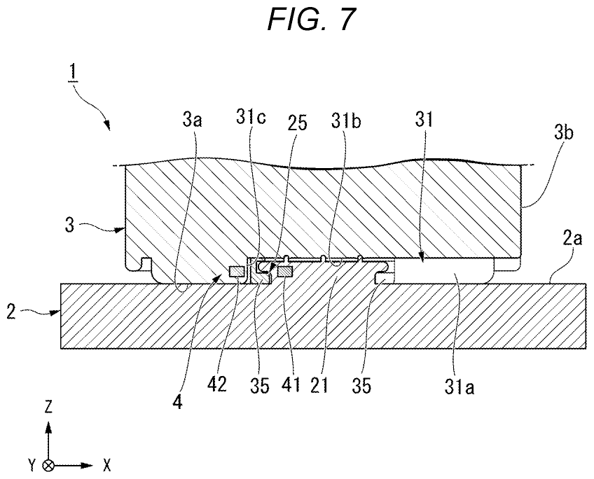

As illustrated in FIGS. 1 to 4, the portable speaker 3 of the present embodiment has the recess portion 31. The recess portion 31 is recessed from an opposing surface 3a of the portable speaker 3 opposing the contact surface 2a of the charging base 2. In a state where the portable speaker 3 is attached on the charging base 2, the opposing surface 3a comes into surface contact with the contact surface 2a of the charging base 2, that is, is parallel to the contact surface 2a (refer to FIGS. 6 and 7).

The recess portion 31 opens not only on the opposing surface 3a of the portable speaker 3 but also on one adjacent surface 3b adjacent to the opposing surface 3a and intersecting the opposing surface 3a. In FIGS. 1 to 4, the adjacent surface 3b of the portable speaker 3 is positioned on the X-axis positive direction side (first direction side) of the opposing surface 3a and is perpendicular to the opposing surface 3a. The recess portion 31 does not open on the X-axis negative direction side (second direction side). As illustrated in FIGS. 3 and 4, the recess portion 31 has an inner end surface 31c positioned at an end portion on the X-axis negative direction side and oriented toward the X-axis positive direction side.

The recess portion 31 has an inner side surface 31a that is perpendicular to the opposing surface 3a and the adjacent surface 3b and extends in the X-axis direction. The inner side surface 31a of the recess portion 31 extends in the X-axis positive direction from the inner end surface 31c of the recess portion 31 to the adjacent surface 3b. The inner side surface 31a of the recess portion 31 is oriented in the Y-axis direction. In addition, a pair of inner side surfaces 31a of the recess portions 31 are provided. The pair of inner side surfaces 31a face each other in the Y-axis direction and extend parallel to each other when viewed from the Z-axis direction (perpendicular direction).

As illustrated in FIGS. 3 and 6, the first locking member 30 of the portable speaker 3 has a locking protrusion 35 provided on the inner side surface 31a of the recess portion 31 described above. The locking protrusion 35 protrudes from the inner side surface 31a in a direction perpendicular to the inner side surface 31a (Y-axis direction). The locking protrusion 35 is provided at a position spaced apart from the bottom surface 31b of the recess portion 31 on the inner side surface 31a of the recess portion 31.

In the present embodiment, the locking protrusion 35 extends in the X-axis positive direction from the inner end surface 31c of the recess portion 31 toward the adjacent surface 3b. Note that a plurality of the locking protrusions 35 may be arranged in the X-axis direction, for example. The locking protrusions 35 are provided on each of the pair of inner side surfaces 31a.

As illustrated in FIGS. 3 and 7, the locking protrusion 35 is also provided on the inner end surface 31c of the recess portion 31. The locking protrusion 35 provided on the inner end surface 31c is provided at a position spaced apart from the bottom surface 31b of the recess portion 31 on the inner end surface 31c. The locking protrusion 35 provided on the inner end surface 31c is formed integrally with the locking protrusion 35 provided on the pair of inner side surfaces 31a.

As illustrated in FIGS. 3 and 4, the locking protrusion 35 is attachable to and detachable from the recess portion 31. In the present embodiment, as described above, the total of three locking protrusions 35 provided on the two inner side surfaces 31a and the one inner side surface 31a of the recess portion 31 are integrally formed. One locking member 37 including three locking protrusions 35 integrated with each other is attachable to and detachable from the recess portion 31.

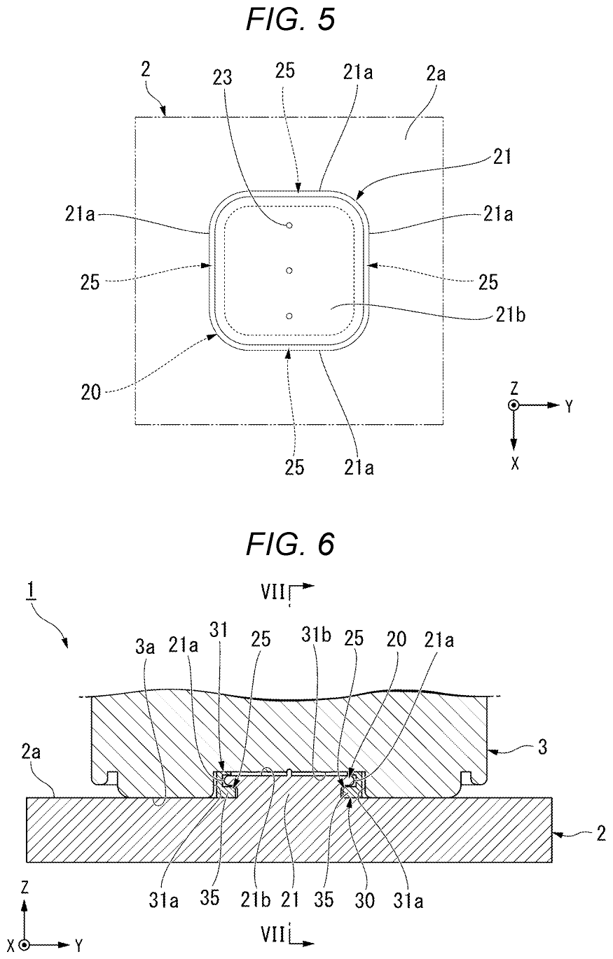

As illustrated in FIGS. 2, 4, and 6, the charging base 2 has a protrusion portion 21 provided on the contact surface 2a. The protrusion portion 21 can be inserted into the recess portion 31 of the portable speaker 3 described above. The protrusion portion 21 has a side surface 21a opposing the inner side surface 31a of the recess portion 31 in a state where the protrusion portion 21 is inserted into the recess portion 31. As illustrated in FIG. 5, the side surface 21a of the protrusion portion 21 extends linearly in one direction along the contact surface 2a when viewed from the Z-axis direction. Hereinafter, the direction in which the side surface 21a of the protrusion portion 21 extends along the contact surface 2a is sometimes referred to as the longitudinal direction of the side surface 21a.

The protrusion portions 21 of the present embodiment have a plurality of pairs of side surfaces 21a. Each pair of side surfaces 21a extends in directions parallel to each other along the contact surface 2a. An interval between side surfaces 21a in each pair is the same as those of the others of the plurality of pairs and corresponds to an interval between each pair of inner side surfaces 31a of the recess portions 31 described above. The different pairs of the side surfaces 21a extend in different directions along the contact surface 2a, respectively.

The number of pairs of the side surfaces 21a of the protrusion portions 21 in the present embodiment is two. Therefore, the protrusion portion 21 is formed in a square shape when viewed from the Z-axis direction. In addition, the corner portion of the square shape of the protrusion portion 21 is rounded when viewed from the Z-axis direction. Note that the number of pairs of the side surfaces 21a may be three or more, for example. That is, the protrusion portion 21 may be formed in a regular polygonal shape when viewed from the Z-axis direction.

As illustrated in FIGS. 4 and 5, the second locking member 20 of the charging base 2 in the present embodiment has a locking groove 25 formed on each side surface 21a of the protrusion portion 21. The locking groove 25 is formed to be recessed from the side surface 21a of the protrusion portion 21, and extends along the longitudinal direction of the side surface 21a. The locking groove 25 is opened at both ends in the longitudinal direction of the side surface 21a. The locking protrusion 35 of the portable speaker 3 described above is inserted into the locking groove 25.

Here, a method of inserting and extracting the locking protrusion 35 of the portable speaker 3 into and from the locking groove 25 of the charging base 2 will be described.

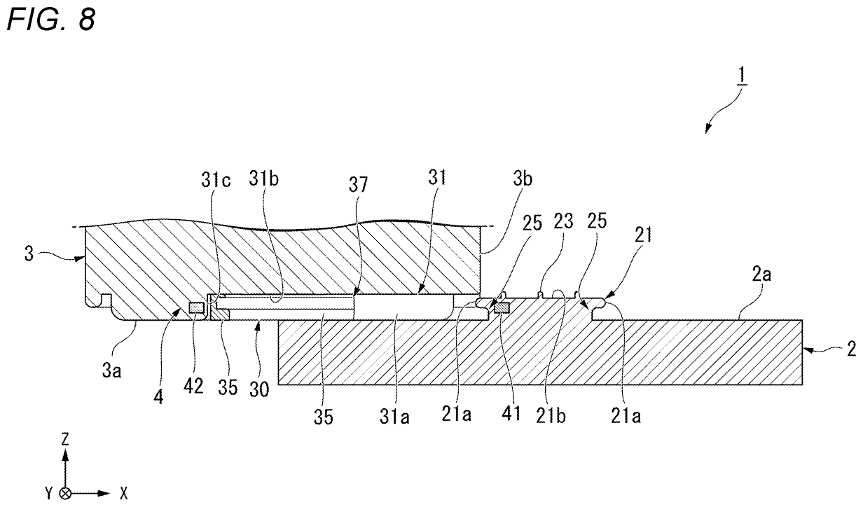

In order to insert the locking protrusion 35 into the locking groove 25, the portable speaker 3 is disposed with respect to the charging base 2 in advance as illustrated in FIGS. 2 and 8. When the portable speaker 3 is disposed, the opening of the recess portion 31 with respect to the adjacent surface 3b of the portable speaker 3 is caused to face the protrusion portion 21 in the direction along the contact surface 2a of the charging base 2. In addition, the longitudinal direction of the pair of inner side surfaces 31a of the portable speaker 3 is made parallel to the longitudinal direction of the selected pair of the side surfaces 21a in the protrusion portions 21. In FIGS. 2 and 8, the portable speaker 3 is disposed on the X-axis negative direction side with respect to the protrusion portion 21, and the opening of the recess portion 31 with respect to the adjacent surface 3b faces the protrusion portion 21 in the X-axis direction (the first direction and the second direction). The longitudinal direction of the pair of inner side surfaces 31a and the longitudinal direction of the selected pair of the side surfaces 21a are along the X-axis direction.

From this state, by slidably moving the portable speaker 3 in the X-axis positive direction (first direction) along the contact surface 2a of the charging base 2, the protrusion portion 21 is inserted into the recess portion 31 from the opening on the adjacent surface 3b side of the recess portion 31, and as illustrated in FIG. 6, the locking protrusion 35 provided on the recess portion 31 is inserted into the locking groove 25 provided on the protrusion portion 21. In this state, the locking protrusion 35 and the locking groove 25 are locked in the Z-axis direction. As a result, separation of the portable speaker 3 from the charging base 2 in the Z-axis direction is restricted.

As illustrated in FIGS. 7 and 8, the inner end surface 31c of the recess portion 31 is positioned on the front side of the inserting direction (X-axis negative direction) of the protrusion portion 21 with respect to the recess portion 31. Therefore, even when the portable speaker 3 is moved further in the X-axis positive direction with respect to the charging base 2 from the state where the protrusion portion 21 is inserted into the recess portion 31 and the locking protrusion 35 is locked in the locking groove 25, the protrusion portion 21 comes into contact with the inner end surface 31c of the recess portion 31, and thus the portable speaker 3 will not be detached from the charging base 2.

In a state where the locking protrusion 35 is locked in the locking groove 25, the portable speaker 3 is placed on the contact surface of the charging base 2 and is attached on the charging base 2.

On the other hand, when the locking protrusion 35 is extracted from the locking groove 25 and the portable speaker 3 is detached from the charging base 2, the portable speaker 3 may be slidably moved in the X-axis negative direction (second direction) along the contact surface 2a of the charging base 2. As a result, the locked state between the locking protrusion 35 and the locking groove 25 is released.

As illustrated in FIGS. 7 and 8, the speaker system 1 of the present embodiment further includes a holding mechanism 4. The holding mechanism 4 holds the locked state (refer to FIG. 6) between the first locking member 30 (locking protrusion 35) and the second locking member 20 (locking groove 25). In the present embodiment, the holding mechanism 4 restricts the sliding movement of the portable speaker 3 in the X-axis negative direction (second direction) with respect to the charging base 2 such that the locking protrusion 35 is not extracted from the locking groove 25.

The holding mechanism 4 illustrated in FIGS. 7 and 8 includes magnets 41 and 42 provided on the portable speaker 3 and the charging base 2. The magnets 41 and 42 are positioned close to each other in a state where the portable speaker 3 is attached on the charging base 2 and the first and second locking members 30 and 20 are locked. In this state, since the magnetic attraction force generated between the magnets 41 and 42 is increased, the magnetic attraction force can hold the portable speaker 3 at the position where the portable speaker 3 is attached on the charging base 2.

As described above, in the speaker system 1 of the present embodiment, the portable speaker 3 can be easily attached to and detached from the charging base 2 by merely slidably moving the portable speaker 3 in the linear directions (the first direction and the second direction) along the contact surface 2a of the charging base 2.

In addition, when the portable speaker 3 is slidably moved to one side of the linear direction (first direction) and attached on the charging base 2, the first locking member 30 of the portable speaker 3 is locked to the second locking member 20 of the charging base 2. In this state, the first locking member 30 and the second locking member 20 restrict the movement of the portable speaker 3 with respect to the charging base 2 in the direction perpendicular to the contact surface 2a, that is, in the direction of being separated from the contact surface 2a of the charging base 2. The locked state between the first locking member 30 and the second locking member 20 is not released unless the portable speaker 3 is moved to the other side of the linear direction (second direction). Therefore, it is possible to prevent the portable speaker 3 from being accidentally detached from the charging base 2.

In the speaker system 1 of the present embodiment, the portable speaker 3 has the recess portion 31 recessed from the opposing surface 3a and also opened on the adjacent surface 3b. In addition, the charging base 2 has a protrusion portion 21 provided on the contact surface 2a and insertable into the recess portion 31. The first locking member 30 of the portable speaker 3 has the locking protrusion 35 provided at a position spaced apart from the bottom surface 31b of the recess portion 31 on the inner side surface 31a of the recess portion 31. Furthermore, the second locking member 20 of the charging base 2 is formed to extend in the linear direction (first direction) on the side surface 21a of the protrusion portion 21, and has a locking groove 25 into which the locking protrusion 35 is inserted. In this configuration, the locking protrusion 35 is inserted into the locking groove 25 by slidably moving the portable speaker 3 along the contact surface 2a of the charging base 2 on one side of the linear direction (first direction) and by inserting the protrusion portion 21 of the charging base 2 into the recess portion 31 from the opening on the adjacent surface 3b side of the portable speaker 3. In this state, since the locking protrusion 35 is locked to the locking groove 25, it is possible to reliably prevent the portable speaker 3 from being separated from the charging base 2 in the direction perpendicular to the contact surface 2a.

In the speaker system 1 of the present embodiment, the locking protrusion 35 is attachable to and detachable from the recess portion 31 of the portable speaker 3. In a state where the locking protrusion 35 is detached from the recess portion 31, it is also possible to insert the protrusion portion 21 of the charging base 2 in and out the recess portion 31 of the portable speaker 3 by moving the portable speaker 3 in the direction (Z-axis direction) of approaching and spacing apart from the contact surface 2a of the charging base 2. In other words, by attaching and detaching the locking protrusion 35 with respect to the recess portion 31, it is possible to select a method of attaching and detaching the portable speaker 3 to and from the charging base 2.

In a state where the locking protrusion 35 is detached from the recess portion 31, even when the portable speaker 3 is attached on the charging base 2, the portable speaker 3 is not locked to the charging base 2, but can be easily attached to and detached from the charging base 2 as compared with a case where the portable speaker 3 is locked to the charging base 2.

In the speaker system 1 of the present embodiment, the recess portion 31 of the portable speaker 3 has a pair of inner side surfaces 31a extending parallel to each other. In addition, the protrusion portion 21 of the charging base 2 has a plurality of pairs of side surfaces 21a, and each pair of side surfaces 21a is parallel to each other. The different pairs of side surfaces 21a extend in directions different from each other. Furthermore, an interval between the pairs of side surfaces 21a is the same as those of the others of the plurality of pairs and corresponds to an interval between the pairs of inner side surfaces 31a of the recess portion 31. As a result, the protrusion portion 21 can be inserted into the recess portion 31 such that the pair of inner side surfaces 31a of the recess portion 31 opposes the selected pair of side surfaces 21a of the protrusion portions 21. Then, by changing the pair of the side surfaces 21a of the protrusion portion 21 corresponding to the pair of inner side surfaces 31a of the recess portion 31, the portable speaker 3 can be attached on the charging base 2 in a plurality of different directions. That is, the portable speaker 3 can be attached on the charging base 2 in a state where the portable speaker 3 is oriented in various directions.

In the present embodiment, the number of pairs of the inner side surfaces 31a of the protrusion portions 21 is two, and the directions in which the pairs of inner side surfaces 31a extend are perpendicular to each other between the two pairs. Therefore, it is possible to attach the portable speaker 3 on the charging base 2 in a direction in which the portable speaker 3 is rotated every 90°.

In the speaker system 1 of the present embodiment, the corner portions of the regular polygonal shape of the protrusion portions 21 are rounded when viewed from the Z-axis direction. The rounded corner portion of the protrusion portion 21 can smoothly guide the protrusion portion 21 into the recess portion 31 from the opening on the adjacent surface 3b side of the recess portion 31.

In the speaker system 1 of the present embodiment, the holding mechanism 4 holds the first locking member 30 and the second locking member 20 in the locked state. As a result, it is possible to prevent or suppress the locked state of the first and second locking members 30 and 20 from being released by the holding mechanism 4. In other words, it is possible to more effectively prevent the portable speaker 3 from accidentally detaching from the charging base 2.

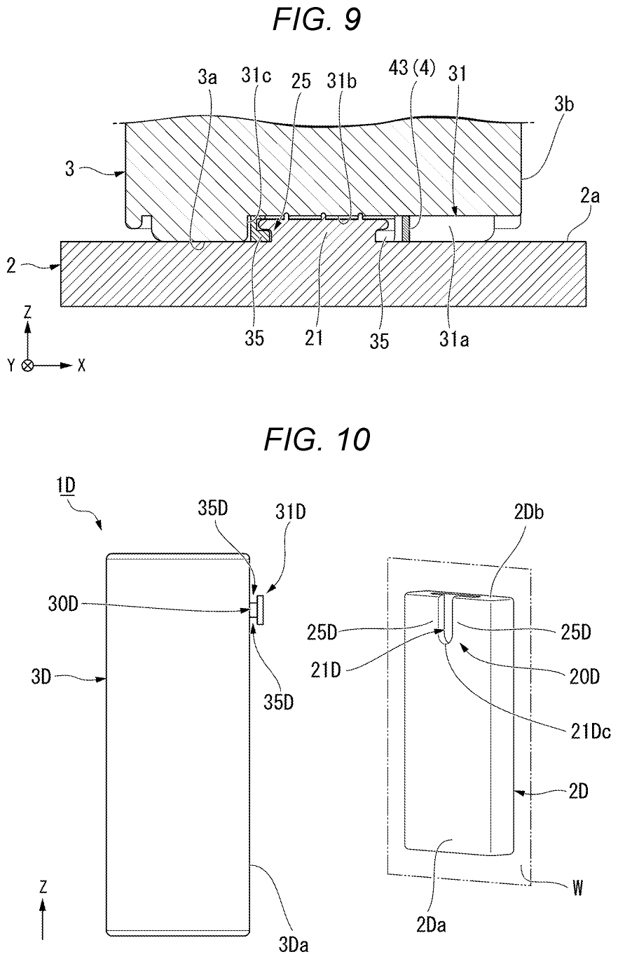

In the first embodiment, for example, as illustrated in FIG. 9, the holding mechanism 4 may be a regulating member 43 that restricts the movement of the portable speaker 3 in the second direction (X-axis negative direction) in a state where the portable speaker 3 is attached on the charging base 2 and the protrusion portion 21 is inserted into the recess portion 31. Although the regulating member 43 illustrated in FIG. 9 is a lid that covers the opening on the adjacent surface 3b side of the recess portion 31, the regulating member 43 is not limited thereto. The regulating member 43 may be, for example, a latch mechanism that restricts the movement in the second direction in a state where the portable speaker 3 is attached on the charging base 2. The latch mechanism is a mechanism having a locking claw that is provided on one of the portable speaker 3 and the charging base 2 and is elastically flexible and deformable, and a locking hole that is provided on the other one and into which the locking claw is inserted in a state where the portable speaker 3 is attached on the charging base 2. By inserting the locking claw into the locking hole, the movement in the second direction is restricted.

In the first embodiment, the locking protrusion 35 may be provided, for example, not to be attachable to and detachable from the inner side surface 31a of the recess portion 31.

### Second Embodiment

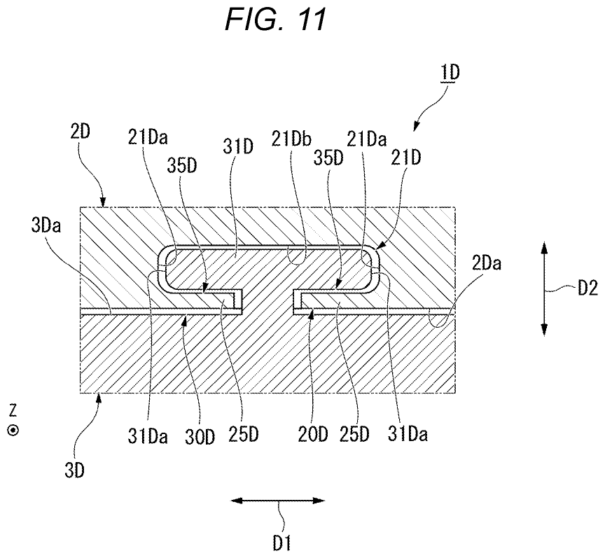

Next, a second embodiment of the present disclosure will be described with reference to FIGS. 10 and 11.

As illustrated in FIGS. 10 and 11, similarly to the first embodiment, a speaker system 1D according to the second embodiment includes a charging base 2D and a portable speaker 3D charged by being attached on the charging base 2D.

The charging base 2D has a contact surface 2Da with which the portable speaker 3D comes into surface contact. However, in the second embodiment, the charging base 2D is disposed such that the contact surface 2Da of the charging base 2D is along the vertical direction (the Z-axis direction). In the second embodiment, the charging base 2D is fixed to a wall surface W extending in the vertical direction. In FIG. 10, the contact surface 2Da of the charging base 2D is oriented in the same direction as the wall surface W, but is not limited thereto.

The portable speaker 3D according to the second embodiment has the same function as the first embodiment and includes a rechargeable battery (not illustrated). In a state where the portable speaker 3D is attached on the charging base 2D, the rechargeable battery of the portable speaker 3D is charged. In the second embodiment, similarly to the first embodiment, the charging of the portable speaker 3D is performed by wired charging.

In the speaker system 1D of the second embodiment, similarly to the first embodiment, by attaching the portable speaker 3D on the charging base 2D, the first locking member 30D of the portable speaker 3D is locked to the second locking member 20D of the charging base 2D in the direction perpendicular to the contact surface 2Da. The first locking member 30D and the second locking member 20D are locked by slidably moving the portable speaker 3D in the first direction along the contact surface 2Da of the charging base 2D with respect to the charging base 2D. In addition, the locked state between the first locking member 30D and the second locking member 20D is released by slidably moving the portable speaker 3D in the second direction opposite to the first direction with respect to the charging base 2D. Hereinafter, a configuration of the speaker system 1D according to the second embodiment including the first locking member 30D and the second locking member 20D will be specifically described.

In the second embodiment, the charging base 2D has a recess portion 21D. The recess portion 21D is recessed from the contact surface 2Da of the charging base 2D. The recess portion 21D opens not only on the contact surface 2Da of the charging base 2D, but also on one adjacent surface 2Db adjacent to the contact surface 2Da and intersecting the contact surface 2Da. In FIG. 10, the adjacent surface 2Db of the charging base 2D is positioned on the Z-axis positive direction side (second direction side) of the contact surface 2Da and is perpendicular to the contact surface 2Da. That is, the recess portion 21D of the charging base 2D also opens upward. A lower end 21Dc of the recess portion 21D does not open on the Z-axis negative direction side (first direction side).

As illustrated in FIG. 11, the recess portion 21D has an inner side surface 21Da that is perpendicular to the contact surface 2Da and extends in the Z-axis direction. The inner side surface 21Da of the recess portion 21D extends in the Z-axis positive direction (second direction) from the lower end 21Dc of the recess portion 21D to the adjacent surface 2Db. The inner side surface 21Da of the recess portion 21D is oriented in the direction perpendicular to the Z-axis direction (D1 direction in FIG. 11) along the contact surface 2Da. In addition, the inner side surfaces 21Da of the recess portion 21D are in pair. The pair of inner side surfaces 21Da face each other in the D1 direction and extend in the Z-axis direction in parallel with each other.

In the second embodiment, the second locking member 20D of the charging base 2D has a locking protrusion 25D provided on the inner side surface 21Da of the recess portion 21D. The locking protrusion 25D protrudes from the inner side surface 21Da in the direction perpendicular to the inner side surface 21Da (D1 direction). The locking protrusion 25D is provided at a position spaced apart from the bottom surface 21Db of the recess portion 21D on the inner side surface 21Da of the recess portion 21D. In the second embodiment, the locking protrusion 25D extends in the Z-axis positive direction from the lower end 21Dc of the recess portion 21D to the adjacent surface 2Db, similarly to the inner side surface 21Da. Note that the locking protrusions 25D may be provided, for example, only on a part of the inner side surface 21Da of the recess portion 21D in the Z-axis direction, or a plurality of locking protrusions 25D may be arranged in the Z-axis direction. The locking protrusions 25D are provided on each of the pair of inner side surfaces 21Da of the recess portion 21D.

As illustrated in FIGS. 10 and 11, the portable speaker 3D has a protrusion portion 31D. The protrusion portion 31D is provided on an opposing surface 3Da of the portable speaker 3D opposing the contact surface 2Da of the charging base 2D. The protrusion portion 31D can be inserted into the recess portion 21D of the portable speaker 3D described above. The protrusion portion 31D has a side surface 31Da opposing the inner side surface 21Da of the recess portion 21D in a state where the protrusion portion 31D is inserted into the recess portion 21D. Similarly to the inner side surface 21Da of the recess portion 21D, the side surface 31Da of the protrusion portion 31D extends in the Z-axis direction (the first direction and the second direction) along the opposing surface 3Da.

In the second embodiment, the first locking member 30D of the portable speaker 3D has a locking groove 35D formed in the protrusion portion 31D. The locking groove 35D is formed to be recessed from at least the side surface 31Da of the protrusion portion 31D, and extends along the longitudinal direction of the side surface 31Da (Z-axis direction in FIG. 11). The locking groove 35D is opened at both ends in the longitudinal direction of the side surface 31Da. The locking protrusion 25D of the portable speaker 3D described above is inserted into the locking groove 35D.

As illustrated in FIG. 10, the locking groove 35D of the second embodiment is also formed to be recessed from the upper end and the lower end of the protrusion portion 31D in the Z-axis direction. In other words, the locking groove 35D is formed entirely around the axis of the protrusion portion 31D, where the axis of the protrusion portion 31D extends in the protruding direction of the protrusion portion 31D. In other words, the distal end portion of the protrusion portion 31D protrudes to the outside of the base end portion of the protrusion portion 31D when viewed from the protruding direction of the protrusion portion 31D.

In order to insert the locking protrusion 25D of the charging base 2D into the locking groove 35D of the portable speaker 3D, the portable speaker 3D is disposed on the charging base 2D such that the protrusion portion 31D of the portable speaker 3D is positioned above the opening of the recess portion 21D with respect to the adjacent surface 2Db of the charging base 2D in the Z-axis direction.

From this state, by slidably moving the portable speaker 3D in the Z-axis negative direction (first direction) along the contact surface 2Da of the portable speaker 3D, the protrusion portion 31D is inserted into the recess portion 21D from the opening on the adjacent surface 2Db side, and the locking protrusion 25D provided in the recess portion 21D is inserted into the locking groove 35D provided in the protrusion portion 31D. In this state, the locking protrusion 25D and the locking groove 35D are locked in a direction perpendicular to the opposing surface 3Da of the portable speaker 3D and the contact surface 2Da of the charging base 2D (D2 direction in FIG. 11). As a result, it is restricted that the portable speaker 3D is separated from the charging base 2D in the D2 direction.

Here, the lower end 21Dc of the recess portion 21D is positioned on the front side of the inserting direction (Z-axis negative direction) of the protrusion portion 31D. Therefore, from the state where the protrusion portion 31D is in contact with the lower end 21Dc of the recess portion 21D, the portable speaker 3D cannot be moved further in the Z-axis negative direction with respect to the charging base 2D. Therefore, the portable speaker 3D will not be detached from the charging base 2D.

As described above, the portable speaker 3D is attached on the charging base 2D. In a state where the portable speaker 3D is attached on the charging base 2D, the portable speaker 3D is disposed to sandwich the charging base 2D with the wall surface W, thereby covering the charging base 2D.

When the portable speaker 3D is detached from the charging base 2D, the portable speaker 3D may be slidably moved in the Z-axis positive direction (second direction) along the contact surface 2Da of the charging base 2D. As a result, the locked state between the locking protrusion 25D and the locking groove 35D is released.

Although not illustrated, similarly to the first embodiment, the speaker system 1D of the second embodiment may include a holding mechanism that holds the locked state between the first locking member 30D (locking groove 35D) and the second locking member 20D (locking protrusion 25D).

As described above, according to the speaker system 1D of the second embodiment, the same advantages as those of the first embodiment can be obtained.

In the speaker system 1D of the second embodiment, the charging base 2D has the recess portion 21D recessed from the contact surface 2Da and also opened on the adjacent surface 2Db. In addition, the portable speaker 3D has the protrusion portion 31D provided on the opposing surface 3Da and insertable into the recess portion 21D. The second locking member 20D of the charging base 2D has the locking protrusion 25D provided spaced apart from the bottom surface 21Db of the recess portion 21D on the inner side surface 21Da of the recess portion 21D. Furthermore, the first locking member 30D of the portable speaker 3D is formed to extend in the linear direction (second direction) along the contact surface 2Da of the charging base 2D on the side surface 31Da of the protrusion portion 31D, and has the locking groove 35D into which the locking protrusion 25D is inserted. In this configuration, the locking protrusion 25D is inserted into the locking groove 35D by slidably moving the portable speaker 3D to one side of the linear direction (first direction) along the contact surface 2Da of the charging base 2D, and by inserting the protrusion portion 31D of the portable speaker 3D into the recess portion 21D from the opening on the adjacent surface 2Db side of the charging base 2D. In this state, since the locking protrusion 25D is locked to the locking groove 35D, it is possible to reliably prevent the portable speaker 3D from being separated from the charging base 2D in the direction perpendicular to the contact surface 2Da.

In the speaker system 1D of the second embodiment, the protrusion portion 31D of the portable speaker 3D is inserted into the recess portion 21D of the charging base 2D from the upper side in the vertical direction (Z-axis positive direction side) of the charging base 2D. In a state where the protrusion portion 31D is inserted into the recess portion 21D, a force oriented to the lower side in the vertical direction, that is, gravity acts on the portable speaker 3D. Therefore, in order to extract the protrusion portion 31D from the recess portion 21D, it is necessary to move the portable speaker 3D against the gravity. Therefore, it is possible to effectively prevent or suppress the portable speaker 3D from being detached from the charging base 2D by utilizing the gravity.

In the speaker system 1D of the second embodiment, as illustrated in FIG. 10, the size of the charging base 2D when viewed from the contact surface 2Da side is smaller than the size of the portable speaker 3D when viewed from the opposing surface 3Da side. Therefore, in a state where the portable speaker 3D is attached on the charging base 2D, the charging base 2D can be covered with the portable speaker 3D and hidden. As a result, it is possible to improve the appearance design of the speaker system 1D in a state where the portable speaker 3D is attached on the charging base 2D.

The configuration of the second embodiment may be applied to, for example, the speaker system 1 of the first embodiment. That is, in the speaker system 1 of the first embodiment, for example, similarly to the second embodiment, the recess portion may be provided on the contact surface 2a of the charging base 2, and the protrusion portion insertable into the recess portion may be provided on the opposing surface 3a of the portable speaker 3. In this case, the second locking member 20 of the charging base 2 may have a locking protrusion formed on the inner side surface of the recess portion, and the first locking member 30 of the portable speaker 3 may have a locking groove formed on the side surface of the protrusion portion. Even in such a configuration, the locking protrusion provided on the charging base 2 may be attachable to and detachable from the recess portion. Furthermore, the protrusion portion of the portable speaker 3 may have a plurality of pairs of inner side surfaces that are parallel to each other, and a plurality of pairs of side surfaces may extend in directions different from each other.

Although the present disclosure has been described in detail above, the present disclosure is not limited to the above-described embodiments, and various modifications can be made without departing from the scope of the appended claims.

In the present disclosure, the charging of the portable speaker is not limited to the wired charging, and may be performed by wireless charging using electromagnetic induction, for example.

What is claimed is:

1. A speaker system comprising:
a portable speaker including a first locking member; and
a charging base including a second locking member,
wherein the first locking member is configured to slide in:
a first direction relative to the second locking member to lock the first and second locking members together; and
a second direction, which is opposite to the first direction, relative to the second locking member to release the first locking member from the second locking member.

2. The speaker system according to claim 1, wherein:
the portable speaker includes a recess portion that includes at least one inner side surface,
the second locking member includes:
a protrusion portion extending from the charging base and insertable into the recess portion; and
a locking groove disposed along at least one side surface of the protrusion,
the first locking member includes a locking protrusion disposed along the at least one inner side surface of the recess portion, and
the at least one side surface opposes the at least one inner side surface in a locked state where the protrusion portion is disposed in the recess portion, the locking groove allowing the first locking member to be slidable in the first and second directions.

3. The speaker system according to claim 2, wherein the first locking member is attachable to and detachable from the recess portion.

4. The speaker system according to claim 2, wherein:
the at least one inner side surface of the recess portion includes a pair of inner side surfaces extending parallel to each other,
the locking protrusion is disposed along each of the inner side surfaces of the recess portion,
the at least one side surface of the protrusion portion includes a plurality of pairs of side surfaces, each of the plurality of pairs of side surfaces being parallel to each other,
the plurality of pairs of side surfaces extend in directions different from each other, and
the locking groove is disposed along the plurality of pairs of side surfaces.

5. The speaker system according to claim 2, wherein a corner portion between adjacent two side surfaces of the protrusion portion is rounded.

6. The speaker system according to claim 2, wherein the locking groove is disposed entirely around the protrusion portion.

7. The speaker system according to claim 1, wherein:
the charging base includes a recess portion that includes at least one inner side surface,
the first locking member includes:
a protrusion portion extending from the portable speaker and insertable into the recess portion; and
a locking groove disposed along at least one side surface of the protrusion,
the second locking member includes a locking protrusion disposed along the at least one inner side surface of the recess portion, and
the at least one side surface opposes the at least one inner side surface in a locked state where the protrusion portion is disposed in the recess portion, the locking groove allowing the first locking member to be slidable in the first and second directions.

8. The speaker system according to claim 7, wherein the locking protrusion is attachable to and detachable from the recess portion.

9. The speaker system according to claim 7, wherein:
the at least one inner side surface of the recess portion includes a pair of inner side surfaces extending parallel to each other,
the locking protrusion is disposed along each of the inner side surfaces of the recess portion,
the at least one side surface of the protrusion portion includes a plurality of pairs of side surfaces, each of the plurality of pairs of side surfaces being parallel to each other,
the plurality of pairs of side surfaces extend in directions different from each other, and
the locking groove is disposed along the plurality of pairs of side surfaces.

10. The speaker system according to claim 7, wherein a corner portion between adjacent two side surfaces of the protrusion portion is rounded.

11. The speaker system according to claim 7, wherein the locking groove is disposed entirely around the protrusion portion.

12. The speaker system according to claim 1, further comprising a holding mechanism configured to hold the first locking member and the second locking member in a locked state.

13. The speaker system according to claim 7, wherein:
the first direction extends downward in a vertical direction, and
the second direction extends upward in the vertical direction. 15

14. The speaker system according to claim 7, wherein a size of the charging base, viewed from a surface of the charging base on which the second locking member is disposed, is smaller than a size of the portable speaker, viewed from a surface of the portable speaker on which the first locking member is disposed.

15. The speaker system according to claim 1, wherein:
the charging base includes a first connection terminal disposed on one side of the charging base,
the portable speaker includes a second connection terminal disposed on one side of the portable speaker, and
the first connection terminal contacts the second connection terminal in a locking state where the first locking member is locked to the second locking member.
